(19) United States
(12) Patent Application Publication
(10) Pub. No.: US 2006/0231025 A1
(43) Pub. Date: Oct. 19, 2006

(54) Programmed material consolidation systems employing object release elements securable to platens for facilitating removal of fabricated objects therefrom

(76) Inventors: Warren M. Farnworth, Nampa, ID (US); Kevin G. Duesman, Boise, ID (US)

Correspondence Address: TRASK BRITT, P.O. BOX 2550, SALT LAKE CITY, UT, 84110, US

(21) Appl. No.: 11/450,719

(22) Filed: Jun. 9, 2006

Related U.S. Application Data
(62) Division of application No. 10/663,402, filed on Sep. 16, 2003.

(51) Int. Cl. B05C 13/00; B05C 11/11; B05B 5/025

(52) U.S. Cl. 118/500; 118/620; 118/504

(57) ABSTRACT

A programmable material consolidation system includes a platen and an object release element on the platen. The object release element includes a lower surface configured to be secured to the platen and readily removed from the platen. An adhesive coating, which may cover at least a portion of the lower surface, may be formed from a material, such as a radiation-curable polymer, that is tacky when in an uncured state and not as tacky when in a substantially cured state. A nonstick coating on the platen may facilitate ready removal of the object release element therefrom. An upper surface of the object release element may include a material to which an object will adhere, but which may be readily removed from the object once fabrication thereof is complete.

### CROSS-REFERENCE TO RELATED APPLICATION

This application is a divisional of application Ser. No. 10/663,402, filed Sep. 16, 2003, pending.

### BACKGROUND OF THE INVENTION

1. Field of the Invention

The present invention relates generally to processes for facilitating the removal of stereolithographically fabricated objects from platens on or over which they are formed and, more specifically, to processes that facilitate the removal of stereolithographically fabricated objects without requiring the use of the material or materials used in fabricating such objects. In particular, the present invention relates to processes which employ an object release element upon which an object may be stereolithographically fabricated and which may subsequently be readily removed from a platen of stereolithographic fabrication equipment and from the stereolithographically fabricated object.

2. Background of Related Art

“Stereolithography” is a manufacturing process that is employed in many industries. Stereolithography, which is also known as “layered manufacturing,” essentially involves the use of a computer to generate a three-dimensional (3-D) mathematical simulation or model of an object to be fabricated. Such a simulation or model is usually generated and manipulated with 3-D computer-aided design (CAD) software. The simulation or model is mathematically separated or “sliced” into a large number of relatively thin, parallel, usually vertically superimposed layers, each layer having defined boundaries and other features associated with the simulation or model and, thus, the actual object to be fabricated at the level of that layer within the exterior boundaries of the object. A complete assembly or stack of all of the layers defines the entire object, and surface resolution of the object is, in part, dependent upon the thicknesses of the layers.

The simulation or model is then employed to generate an actual object by building the object, layer by superimposed layer. A wide variety of approaches to stereolithography by different companies has resulted in techniques for fabrication of objects from a variety of materials. As shown in FIG. 1, many stereolithographic fabrication techniques involve the disposition of a layer 4′ of unconsolidated or unfixed material 3 corresponding to each layer of the simulation or model and, thus, of an object 5 to be fabricated. Next, unconsolidated or unfixed material 3 at and within at least portions of the boundaries of that layer 4′ of object 5 is selectively consolidated or fixed to an at least a partially consolidated, or semisolid, state. At the same time, material 3 of a layer 4′ under fabrication may be adhered or bonded to a next-lower layer 4 of object 5.

Depending upon the type of stereolithographic technique being employed, as well as the stereolithographic fabrication equipment used to effect the technique, the unconsolidated or unfixed material 3 employed to build object 5 may be supplied in particulate or liquid form, and unconsolidated or unfixed material 3 may itself be consolidated or fixed, or a separate binder material may be employed to bond material particles to one another and to those of a previously formed layer.

When particulate materials are employed, resolution of object surfaces is highly dependent upon particle size, whereas when a liquid is employed, surface resolution is highly dependent upon the minimum surface area of the liquid which can be fixed and the minimum thickness of a layer that can be generated. Of course, in either case, resolution and accuracy of object reproduction from the CAD file is also dependent upon the ability of the apparatus used to fix the material to precisely track the mathematical instructions indicating solid areas and boundaries for each layer of material. Toward that end, and depending upon the layer being fixed, various fixation approaches have been employed, including particle bombardment (electron beams), disposing a binder or other fixative (such as by ink-jet printing techniques), or irradiation using heat or specific wavelength ranges.

The latter irradiation approach may be effected with the SLA-250/50HR, SLA-5000, and SLA-7000 stereolithography systems that are offered by 3D Systems, Inc., of Valencia, Calif., using ultraviolet-curable polymers, or “photopolymers,” such as CIBATOOL SL 5170 and SL 5210 resins (for the SLA-250/50HR system), CIBATOOL SL 5530 resin (for the SLA-5000 and SLA-7000 systems), and CIBATOOL SL 7510 resin (for the SLA-7000 system), each of which is available from Ciba Specialty Chemicals Company. Examples of the processes that may be used in performing these techniques are described in various United States Patents that have been assigned to 3D Systems, including, without limitation, U.S. Pat. Nos. 4,575,330; 4,929,402; 4,996,010; 4,999,143; 5,015,424; 5,058,988; 5,059,021; 5,059,359; 5,071,337; 5,076,974; 5,096,530; 5,104,592; 5,123,734; 5,130,064; 5,133,987; 5,141,680; 5,143,663; 5,164,128; 5,174,931; 5,174,943; 5,182,055; 5,182,056; 5,182,715; 5,184,307; 5,192,469; 5,192,559; 5,209,878; 5,234,636; 5,236,637; 5,238,639; 5,248,456; 5,256,340; 5,258,146; 5,267,013; 5,273,691; 5,321,622; 5,344,298; 5,345,391; 5,358,673; 5,447,822; 5,481,470; 5,495,328; 5,501,824; 5,554,336; 5,556,590; 5,569,349; 5,569,431; 5,571,471; 5,573,722; 5,609,812; 5,609,813; 5,610,824; 5,630,981; 5,637,169; 5,651,934; 5,667,820; 5,672,312; 5,676,904; 5,688,464; 5,693,144; 5,695,707; 5,711,911; 5,776,409; 5,779,967; 5,814,265; 5,850,239; 5,854,748; 5,855,718; 5,855,836; 5,885,511; 5,897,825; 5,902,537; 5,902,538; 5,904,889; 5,943,235; and 5,945,058. The disclosure of each of the foregoing patents is hereby incorporated herein in its entirety by this reference.

When ultraviolet-curing stereolithographic techniques are used to fabricate objects, the objects are formed directly on a support surface of a platen, or tray, of a stereolithographic fabrication apparatus. When cured, the ultraviolet-curable materials that are usually used in such processes typically adhere to the platen. Thus, an object which has been stereolithographically fabricated from ultraviolet-curable materials is typically removed from the platen on which it was formed by way of mechanical removal processes.

In order to facilitate removal of a stereolithographically fabricated object from a platen 112 and reduce damage to a stereolithographically fabricated object 5 during the removal process, and as shown in FIG. 2, substructures, such as extremely fine columns, or “hairs” 6, may be stereolithographically fabricated on a support surface 114 of platen 112 prior to stereolithographic fabrication of object 5 thereon. After hairs 6 have been fabricated to a desired height, a mesa-like structure 7 is formed thereover. The desired object 5 is then formed, layer by superimposed layer, in accordance with programming of a stereolithographic system controller, such as a computer. The system controller controls the depth the platen is lowered into a bath of ultraviolet-curable polymer, as well as the locations of a layer of such polymer that are to be exposed to ultraviolet radiation, which is typically embodied as a laser beam.

Once the desired object has been fabricated, the hairs may be cut. The portions of hairs 6 that remain on the fabricated object 5 may also be removed therefrom, such as by sanding, as may the mesa-like structure 7.

Although this practice has found widespread use in ultraviolet-curing stereolithography techniques, it remains somewhat undesirable due to the amount of expensive, ultraviolet-curable polymer that is required just for forming the hairs. Also, the amount of equipment time that is needed to fabricate the hairs is significant and could be put to better use in fabricating the finished product. Further, a significant amount of time is required to finish the bottom surface of each fabricated object by removing the remainders of any hairs therefrom and, possibly, the mesa-like structures that were formed above the hairs.

Accordingly, there is a need for a process and element to facilitate the release of objects from the platens of stereolithographic fabrication equipment without consuming excess stereolithographic fabrication material and without requiring additional finishing of the stereolithographically fabricated object.

### SUMMARY OF THE INVENTION

The present invention, in one embodiment, includes a process for facilitating the removal of stereolithographically fabricated objects from the platens on or over which they are formed. Processes for forming object release elements in accordance with teachings of the present invention do not require the use of the same material or materials that are to be used to stereolithographically fabricate one or more objects that will have to be removed from the platen of a stereolithographic fabrication apparatus.

As an example of a process according to the present invention, an object release element that may subsequently be readily removed from a platen of stereolithographic fabrication equipment and from the stereolithographically fabricated object may be used. Initially, the object release element is secured to a platen of stereolithographic fabrication equipment. An object is then fabricated, using stereolithographic fabrication techniques, directly on the object release element. Once the object has been fabricated, the object release element may be removed from both the platen and the stereolithographically fabricated object.

An object release element that is useful in a process according to the present invention and, thus, which incorporates teachings of the present invention, comprises a substrate which includes an upper surface and a lower surface. The upper surface of the substrate, which is configured to have one or more objects stereolithographically fabricated thereon, may remain exposed when the object release element is secured to a platen. The material from which the substrate is formed, or from which a layer on the upper surface of the substrate is formed, may temporarily adhere to a stereolithographically fabricated object thereon, but readily release, or peel, from the stereolithographically fabricated structure when such removal is desired, such as when the object release element is pulled away from a fabricated object with sufficient force.

The lower surface of the substrate may be coated with a material, such as a suitable adhesive, which facilitates adhesion of the object release element to a platen of stereolithographic fabrication equipment, as well as removal of the object release element from the platen. By way of example only, a polymer, such as an ultraviolet-curable adhesive, that adheres to the material (e.g., stainless steel, quartz, etc.) of the platen when in an uncured state, but has reduced adhesion to the material of the platen when in a cured state, may be used. Alternatively, the lower surface of the substrate of the object release element may be coated with a suitable pressure sensitive adhesive. As yet another example, the lower surface of the substrate of an object release element incorporating teachings of the present invention may be configured to seal against a platen of a stereolithographic fabrication apparatus when a negative pressure (e.g., a vacuum) is applied thereto through the platen (e.g., lower surface may be substantially planar, comprise a somewhat conformable material, etc.).

Thus, the present invention also includes stereolithographic fabrication apparatus with platens that are configured to communicate a negative pressure to support surfaces thereof.

Object release elements and processes that incorporate teachings of the present invention may be used to stereolithographically fabricate any type of object, including, but not limited to, so-called “rapid prototypes” and mass-produced structures, such as components that are to be used with semiconductor devices, or “semiconductor device components.” By way of example only, stereolithographic processes may be used to fabricate test sockets and burn-in sockets of various configurations, as well as other semiconductor device components that are currently made by use of molding processes.

The present invention also includes stereolithographic systems that include the object release elements on the platens thereof, methods for stereolithographically fabricating objects by using the object release elements, and the objects that are produced when object release elements that incorporate teachings of the present invention are used in stereolithographic fabrication processes.

Other features and advantages of the present invention will become apparent to those of ordinary skill in the art through consideration of the ensuing description, the accompanying drawings, and the appended claims.

### BRIEF DESCRIPTION OF THE SEVERAL VIEWS OF THE DRAWINGS

In the drawings, which depict exemplary embodiments of various aspects of the present invention:

FIG. 1 schematically depicts an example of a conventional stereolithography process;

FIG. 2 is a side view illustrating the result of a conventional process for facilitating the removal of a stereolithographically fabricated object from the platen on or over which it has been fabricated;

FIG. 3 is a cross-sectional representation of an exemplary object release element that embodies teachings of the present invention and which includes a substantially planar substrate that is formed from a material which is removable from a stereolithographically fabricated object;

FIG. 3A is a cross-sectional representation of an exemplary object release element of the present invention and which includes a lower surface which is configured to be secured to a platen by way of a negative pressure communicated to a support surface of the platen;

FIG. 4 is a cross-sectional representation of another exemplary embodiment of object release element according to the present invention, which includes an object release coating on a substantially planar substrate thereof, the object release coating being formed from a material that is removable from a stereolithographically fabricated object;

FIG. 5 is a cross-sectional representation of an exemplary embodiment of an object release element that includes a nonplanar fabrication surface;

FIG. 6 is a cross-sectional representation of still another exemplary embodiment of object release element, which is configured for use in forming objects that include regions that overhang the object release element and, thus, which protrude from a lower surface an object formed thereon;

FIG. 7 is a schematic representation depicting placement of an object release element of the present invention on a platen of stereolithographic fabrication equipment;

FIGS. 8 through 10 are schematic representations that show stereolithographic fabrication of an object over an object release element that has been secured to the platen of stereolithographic fabrication equipment;

FIGS. 11 and 12 are schematic representations that illustrate exemplary acts that may be effected to remove the object release element from the platen; and

FIGS. 13 and 14 schematically depict removal of the object release element from the object that has been stereolithographically fabricated thereon.

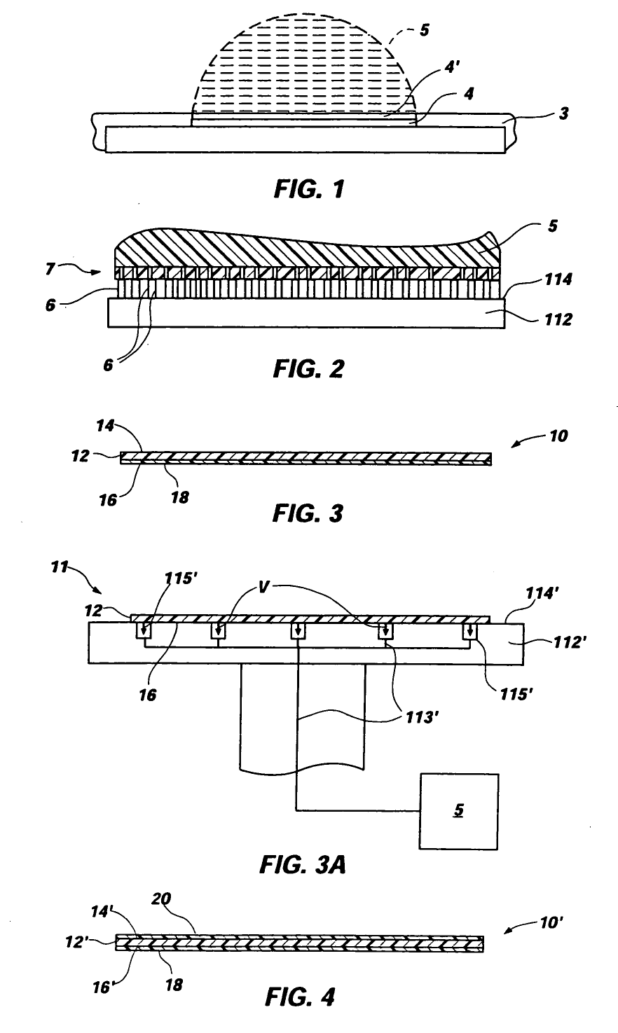

### DETAILED DESCRIPTION OF THE INVENTION

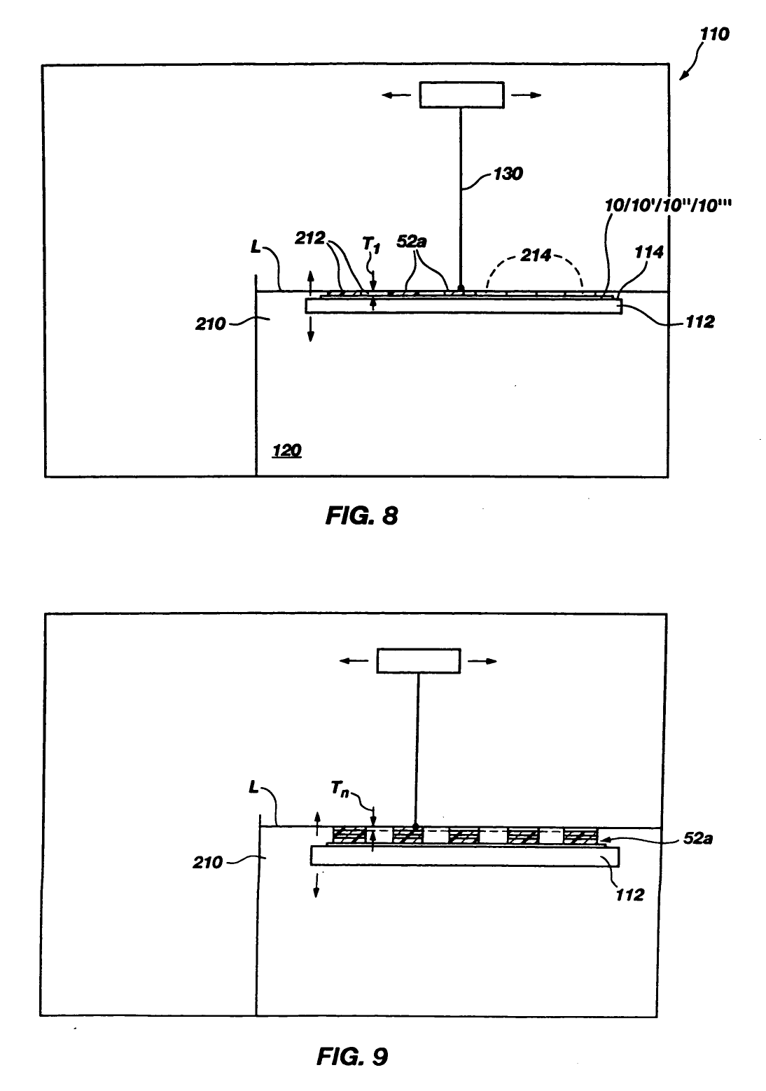

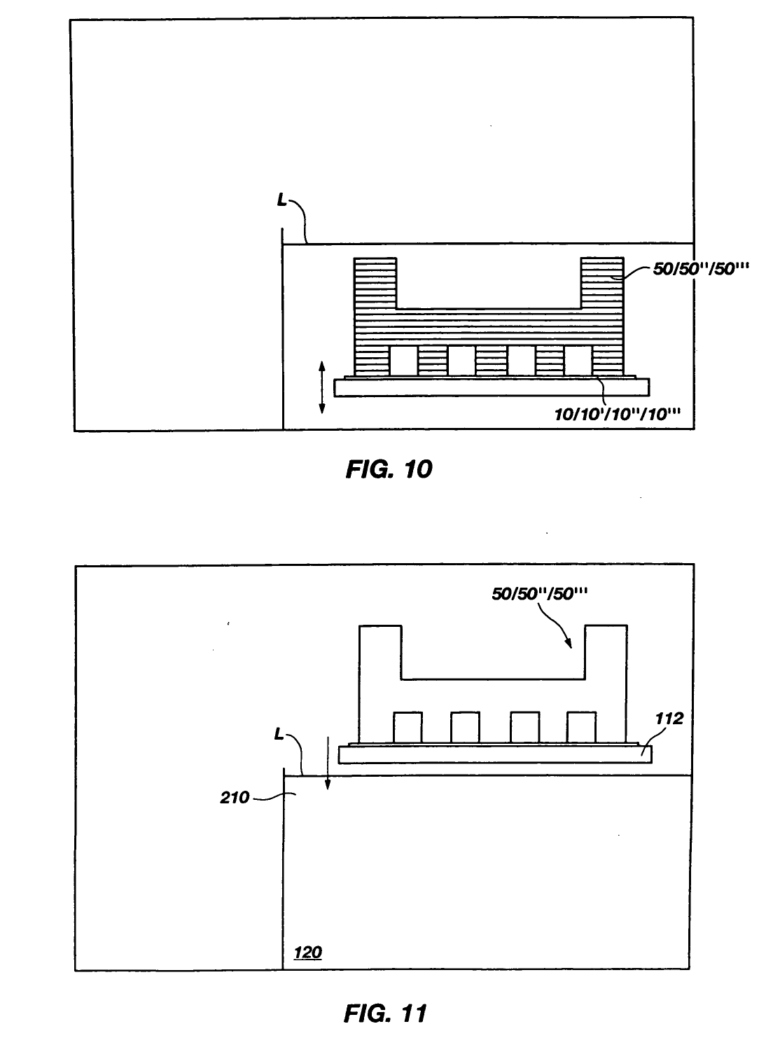

An exemplary embodiment of object release element 10 that incorporates teachings of the present invention is shown in FIG. 3. Object release element 10 includes a substantially planar substrate 12 which has a shape and dimensions that are suitable for placement over at least a portion of a platen 112 of stereolithographic fabrication equipment 110 (FIG. 8) by which one or more objects 50 (FIG. 10) will be formed. In addition, object release element 10 includes an adhesive coating 18 on a lower surface 16 of substantially planar substrate 12, while an upper surface 14 of substantially planar substrate 12 remains exposed.

Substantially planar substrate 12 comprises a material to which selectively consolidated regions of a lowermost layer of an object 50 (FIG. 10) under fabrication will adhere, but which is readily removable therefrom, such as by peeling (i.e., pulling on substantially planar substrate 12 with sufficient force to remove the same from object 50), by etching, as known in the art and as suitable for removing the material of substantially planar substrate 12 without substantially removing or otherwise adversely affecting the material of object 50, or by any other suitable technique.

Examples of materials from which substantially planar substrate 12 may be formed include, but are not limited to, polyethylene (“PE”), polyethyleneteraphthalate (“PET”), and polyethylene ethyl ketone (“PEK”).

Adhesive coating 18 comprises a material which will adhere to a surface of platen 112 of stereolithographic fabrication equipment 110 (FIG. 8) while an object 50 (FIG. 10) is being stereolithographically fabricated thereon, but which may be readily removed from platen 112 once the stereolithographic fabrication of object 50 is complete. By way of example only, a material that is tacky and, thus, adheres to a support surface 114 of platen 112 when in an uncured or partially cured state, but which releases from platen when cured, or cross-linked (e.g., by exposure to a sufficient dosage of ultraviolet (UV) radiation, heat, etc.), may be used as adhesive coating 18. UV-curable materials that have these properties include, without limitation, light-curable adhesives available from 3M Company of St. Paul, Minn., and the adhesives that are currently used on the ICROS® tapes of Mitsui Chemicals America, Inc., of Purchase, N.Y.

FIG. 3A shows an embodiment of object release element 11 that includes a substrate 12 with a lower surface 16 which is configured to be secured to a support surface 114′ of a platen 112′ of a stereolithographic fabrication apparatus (e.g., stereolithographic fabrication apparatus 110 of FIGS. 8 through 12) by way of a negative pressure V (e.g., a vacuum). Thus, object release element 11 may lack the adhesive coating (FIG. 3) of object release element 10. Negative pressure V may be communicated to support surface 114′ from a negative pressure source S through one or more conduits 113′ within or otherwise associated with platen 112′ and ports 115′ that communicate with both conduit 113′ and support surface 114′. Lower surface 16 may merely comprise a substantially planar surface, or substrate 12 may be formed from a material (e.g., a somewhat conformable material) which seals against support surface 114′ as a negative pressure is applied through platen 112′ to lower surface 16.

Another exemplary embodiment of object release element 10′ according to the present invention is shown in FIG. 4. In addition to a substantially planar substrate 12′ and an adhesive coating 18 on a lower surface 16′ of substantially planar substrate 12′, object release element 10′ includes an object release coating 20 on an upper surface 14′ of substantially planar substrate 12′. Object release coating 20 may be formed from a material, such as PE, PET, or PEK, that will adhere to, but is readily removable from, a stereolithographically fabricated object 50 (FIG. 10). As such, substantially planar substrate 12′ may be formed from any suitable material to which an object release coating 20 will adhere, at least until removal of object release element 10′ from an object 50 is desired.

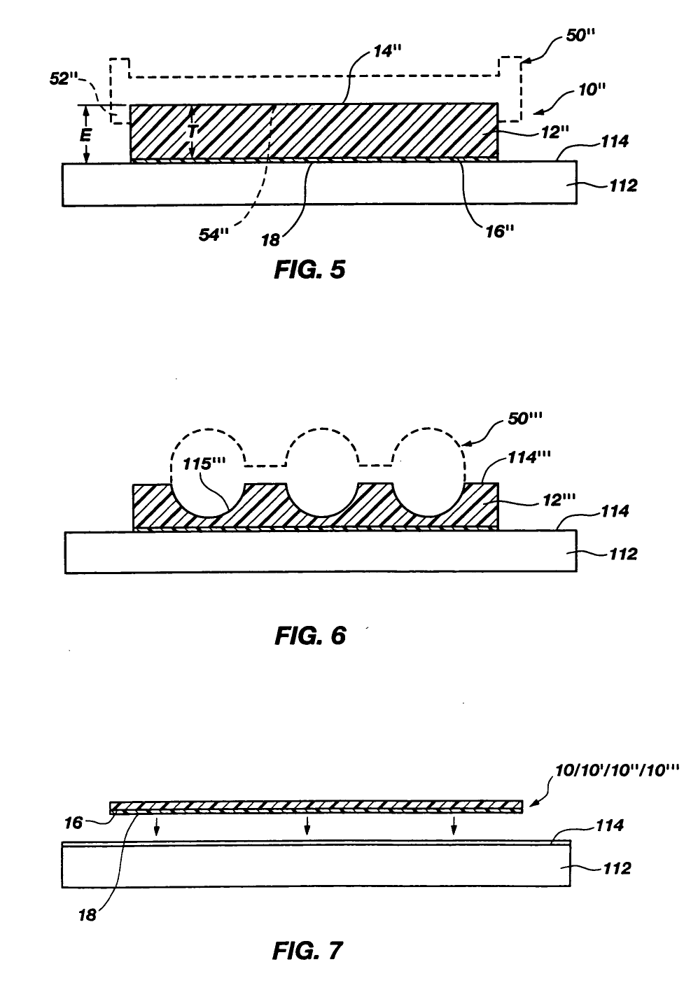

Turning now to FIG. 5, another embodiment of object release element 10″ according to the present invention is depicted. Object release element 10″ includes a substrate 12″, which includes substantially planar, parallel, opposite upper and lower surfaces 14″ and 16″, respectively, and which has a thickness T that is greater than those of substrates 12 and 12′ of object release elements 10 and 10′, respectively (FIGS. 3 and 4, respectively). Accordingly, upper surface 14″ of substrate 12″ of object release element 10″ is elevated above a support surface 114 of a platen 112 upon which object release element 10″ is placed by a distance E which is at least as great as thickness T. As such, object release element 10″ is useful for fabricating one or more objects 50″ that include features 51″ that protrude from a fabrication surface 54″ thereof located over upper surface 14″, or which intersect a plane on which fabrication surface 54″ resides. Accordingly, thickness T of substrate 12″ is about the same dimension as or larger than a distance P that feature 51″ extends beyond lowermost fabrication surface 54″ of object 50″.

Of course, the material from which substrate 12″ is formed may adhere to, but be readily removable from, a stereolithographically fabricated object 50″, or substrate 12″ may include a coating (not shown) of such a material on an upper surface 14″ thereof, as described with respect to object release element 10′, which is depicted in FIG. 4.

In order to facilitate adhesion of object release element 10″ to support surface 114 of platen 112 of stereolithographic fabrication equipment 110 (FIG. 8), an adhesive coating 18, such as that described above in reference to object release elements 10 and 10′ depicted in FIGS. 3 and 4, respectively, may be located on at least a portion of lower surface 16″ of substrate 12″ of object release element 10″.

FIG. 6 illustrates an object release element 10′″ which includes a three-dimensional substrate 12′″. Substrate 12′″ may be formed from a material that will adhere to, but is readily removable from, a stereolithographically fabricated object 50′″, or it may include a coating (not shown) of such material on an upper surface 14′″ thereof, as described with respect to object release element 10′, which is depicted in FIG. 4.

With continued reference to FIG. 6, as lower surface 16′″ of substrate 12′″ is configured to be placed against a support surface 114 of a platen 112 of stereolithographic fabrication equipment 110 (FIG. 8), lower surface 16′″ is substantially planar. Like object release elements 10 and 10′, object release element 10′″ includes an adhesive coating 18 on at least a portion of lower surface 16′″ thereof so that object release element 10′″ may be secured to support surface 114 of platen 112 during stereolithographic fabrication of one or more objects 50′″ thereon and to facilitate ready removal of each object 50′″ from support surface 114 of platen 112 once stereolithographic fabrication processes have been completed.

Upper surface 14′″ of substrate 12′″, against which an object 50′″ is to be fabricated, is, however, nonplanar. The contour of upper surface 14″ may correspond to (i.e., act as a “negative” for) a corresponding bottom surface of each object 50′″ that is to be stereolithographically fabricated on object release element 10′″. As shown in FIG. 6, upper surface 14′″ of substrate 12′″ includes a concave recess 15′″, within which a complementary convex surface 53′″ of an object 50″ may be formed during the stereolithographic fabrication of object 50′″. Of course, upper surfaces 14′″ having other nonplanar configurations, including other configurations of recesses, are also within the scope of the present invention.

Turning now to FIG. 7, placement of an object release element 10, 10′, 10″, 10′″ that incorporates teachings of the present invention onto a platen 112 of stereolithographic fabrication equipment 110 (FIG. 8) is depicted.

Initially, to facilitate removal of object release element 10, 10′, 10″, 10′″ from a support surface 114 of platen 112, support surface 114 may be at least partially formed from a material from which cured adhesive coating 18 may be readily removed, or a “nonstick material.” By way of example only, a nonstick material such as a TEFLON® fluorine-containing polymer available from E.I. du Pont de Nemours & Company of Wilmington, Del., or a fluorine-containing polymer available from another source may be used, employing known processes, to form at least a portion of support surface 114 or a lining or coating thereon.

If support surface 114 does not include a material from which adhesive coating 18 may be readily removed, at least a portion of a support surface 114 of platen 112 may be lined or coated with a layer 116 of nonstick material. By way of example only, layer 116 may be formed on an upper surface 114 of a platen 112 (e.g., a platen that includes stainless steel, quartz, etc.) by using known techniques to vapor deposit a fluorine-containing polymer, such as TEFLON®.

Object release element 10, 10′, 10″, 10′″ is oriented over support surface 114 of platen 112 with lower surface 16 thereof and adhesive coating 18 facing support surface 114. Once object release element 10, 10′, 10″, 10′″ has been positioned over support surface 114 as desired, object release element 10, 10′, 10″, 10′″ may be temporarily secured in position relative to support surface 114 by way of the tackiness of adhesive coating 18. The tackiness of adhesive coating 18 provides sufficient adhesion to support surface 114 or a layer 116 thereon so that object release element 10, 10′, 10″, 10′″ will maintain a stationary position relative to platen 112 as an object 50 (FIG. 10) is being stereolithographically fabricated on object release element 10, 10′, 10″, 10′″.

With returned reference to FIG. 3A, object release element 11 may be secured to platen 112′ by placing object release element 11 on support surface 114′ of platen 112′ and actuating source S such that negative pressure V is applied through conduit 113′ and ports 115′ to lower surface 16 of substrate 12 of object release element 11.

Once object release element 10, 10′, 10″, 10′″ has been secured to support surface 114 of platen 112 or, as shown in FIG. 3A, once object release element 11 has been secured to support surface 114′ of platen 112′, stereolithographic fabrication of one or more objects 50, 50″, 50′″ (FIG. 10) on object release element 10, 10′, 10″, 10′″, or 11 may commence, as known in the art, without the need for conventional preliminary fabrication of hairs or mesas. FIGS. 8 through 10 depict an exemplary process for fabricating an object 50, 50″, 50′″ on an object release element 10, 10′, 10″, 10′″ according to the present invention. Although FIGS. 8 through 10 do not depict the fabrication of an object 50, 50″, 50′″ on object release element 11, the same object fabrication processes described hereinafter may be employed when object release element 11 is used.

As shown in FIG. 8, platen 112, with object release element 10, 10′, 10″, 10′″ secured to upper surface 114 thereof, is lowered into a tank 120 of stereolithographic fabrication equipment 110. Tank 120 is partially filled to a predetermined level L with unconsolidated material 210, such as a photopolymer (e.g., a UV-curable polymer, such as CIBATOOL SL 5170 and SL 5210 resins (for the SLA-250/50HR system), CIBATOOL SL 5530 resin (for the SLA-5000 and SLA-7000 systems), and CIBATOOL SL 7510 resin (for the SLA-7000 system) each of which is available from Ciba Specialty Chemicals Company)). Initially, platen 112 is lowered into unconsolidated material 210 a sufficient distance that a layer 212 of unconsolidated material 210 of desired thickness T₁ is formed over object release element 10, 10′, 10″, 10′″. Focused consolidating energy 130, such as a beam (e.g., a laser beam) of a wavelength or range of wavelengths (e.g., UV radiation) suitable for at least partially consolidating unconsolidated material 210, is then directed onto selected regions 214 of layer 212 to at least partially cure unconsolidated material 210 located in selected regions 214. Of course, the movement of focused consolidating energy 130 may be controlled, such as by way of a controller that operates in accordance with programming for fabricating a first layer 52a of an object 50, 50″, 50′″ (FIG. 10), as known in the art of stereolithography. When first layer 52a is completely formed, platen 112 may again be lowered a sufficient distance to form another layer 52n of unconsolidated material 210 of a corresponding thickness Tₙ over first layer 52a, and the selective consolidation of unconsolidated material within specified regions of that layer effected, over and over again, as shown in FIG. 9, until the stereolithographic fabrication of each object 50, 50″, 50′″ on object release element 10, 10′, 10″, 10′″ is complete, as shown in FIG. 10.

Turning now to FIG. 11, once object 50, 50″, 50′″ is complete, platen 112 may be raised above level L so that unconsolidated material 210 that remains on object 50, 50″, 50′″ and platen 112 may be recovered within tank 120, as known in the art. In this manner, unused unconsolidated material 210 may be preserved for subsequent use.

In addition, either prior to, during, or after the removal of object 50, 50″, 50′″ from tank 120, adhesive coating 18 (FIGS. 3 through 6) of object release element 10, 10′, 10″, 10′″ may be exposed to conditions that will facilitate the removal of object release element 10, 10′, 10″, 10′″ and, thus, object 50, 50″, 50′″ from platen 112.

By way of example only, when a UV-curable material or light-curable material is employed as adhesive coating 18, adhesive coating 18 may be exposed to a sufficient dosage of radiation of one or more appropriate wavelengths to initiate cross-linking, or curing, of the material of adhesive coating 18. Such exposure may be effected until the material of adhesive coating 18 is substantially cross-linked, or cured, or followed with exposure of adhesive coating 18 to other conditions, such as increased temperature, that will facilitate further cross-linking, or curing, thereof.

Alternatively, if a heat-curable material is employed as adhesive coating 18, adhesive coating 18 may heated to a sufficient temperature to cross-link, or cure, the same.

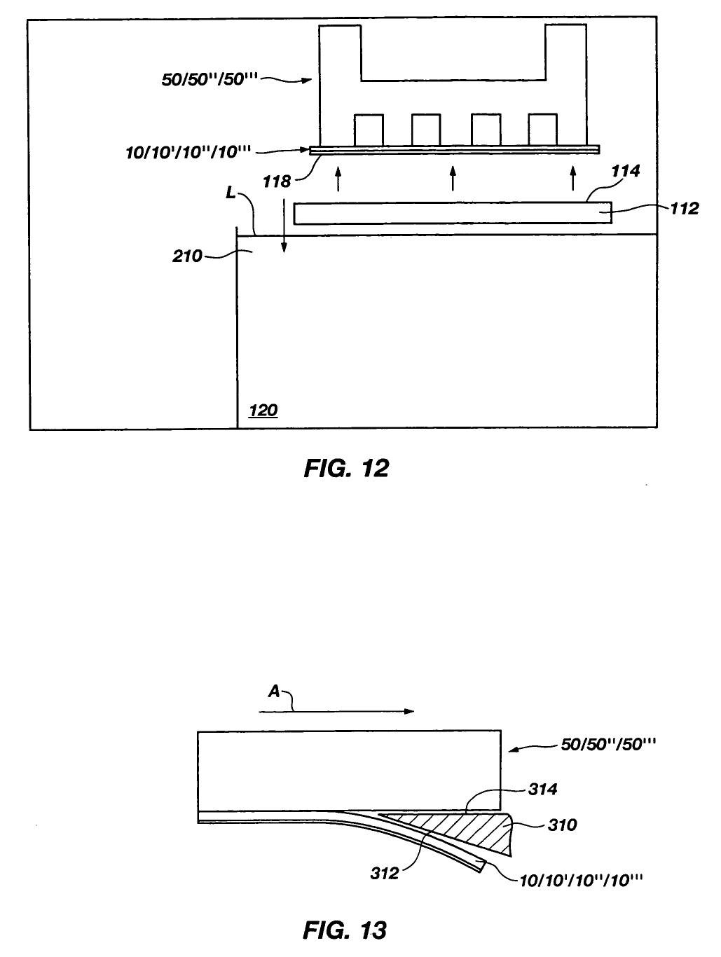

When the material of adhesive coating 18 has been substantially cured, it will no longer adhere to the nonstick material of upper surface 114 of platen 112 or of a nonstick layer 116 thereon. As a result, object release element 10, 10′, 10″, 10′″ and each object 50, 50″, 50′″ carried thereby may be readily removed from upper surface 114 of platen 112, as illustrated in FIG. 12. Additionally, by substantially curing the material of adhesive coating 18, substantially no residual adhesive material will remain on upper surface 114 of platen 112, eliminating the need to clean the same and, thus, the associated potential for damaging upper surface 114.

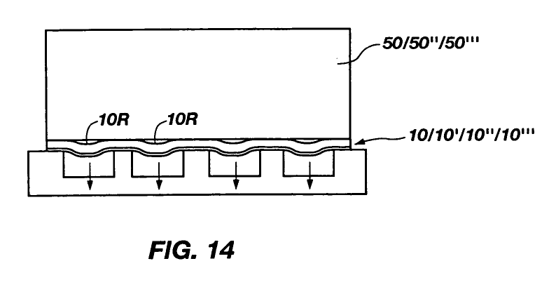

Referring now to FIGS. 13 and 14, exemplary methods for removing object release element 10, 10′, 10″, 10′″ from one or more fabricated objects 50, 50″, 50′″ are depicted.

As shown in FIG. 13, object release element 10, 10′, 10″, 10′″ may be peeled from each object 50, 50″, 50′″ that has been stereolithographically fabricated thereon. As is well known, peeling may be effected by pulling one or both of object release element 10, 10′, 10″, 10′″ and an object 50, 50″, 50′″ thereon away from the other. Such peeling may be effected manually or mechanically. By way of example only, object release element 10, 10′, 10″, 10′″ may be pulled away from one or more objects 50, 50″, 50′″ by placing an edge of object release element 10, 10′, 10″, 10′″ on one side 312 of a separating edge 310 with the majority of each object 50, 50″, 50′″ being located on the opposite side 314 of separating edge 310. A pulling force, exerted substantially along the plane of object release element 10, 10′, 10″, 10′″, as shown by arrow A, is then applied to force object release element 10, 10′, 10″, 10′″ and each object 50, 50″, 50′″ carried thereby onto opposite sides 312 and 314, respectively, of separating edge 310. This process continues until object release element 10, 10′, 10″, 10′″ has been completely removed from each object 50, 50″, 50′″ that was stereolithographically fabricated thereon.

FIG. 14 depicts another exemplary method for removing objects 50, 50″, 50′″ from object release elements 10, 10′, 10″, 10′″. The method depicted in FIG. 14, which employs equipment similar to that described in U.S. Pat. No. 6,202,292, issued to Farnworth et al. on Mar. 20, 2001, the entire disclosure of which is hereby incorporated herein by this reference, includes reducing the adhesion of regions of object release element 10, 10′, 10″, 10′″ to one or more objects 50, 50″, 50′″ thereon by applying negative pressure (e.g., vacuum), shown as arrows V, to regions of at least a portion 10R thereof while an object 50, 50″, 50′″ located opposite that portion of object release element 10, 10′, 10″, 10′″ is maintained in a substantially stationary position. Each object 50, 50″, 50′″ over a region 10R of reduced adhesion may then be removed (e.g., by pulling the same) from object release element 10, 10′, 10″, 10′″ with relative ease, such as by use of a vacuum pick-up head, mechanically, or manually.

Of course, other techniques for removing object release element 10, 10′, 10″, 10′″ from one or more stereolithographically fabricated objects may also be used without departing from the scope of the present invention.

It is currently preferred that the technique that is employed leave substantially no pieces of object release element 10, 10′, 10″, 10′″ or residue therefrom on object 50, 50″, 50′″. It is also currently preferred that little or no additional finishing of the surface 54 of object 50, 50″, 50′″ that was located adjacent to object release element 10, 10′, 10″, 10′″ prior to removing the same from object 50, 50″, 50′″ be required.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Moreover, features from different embodiments of the invention may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

What is claimed:

1. A programmable material consolidation system, comprising:
a fabrication site;
a platen within the fabrication site and including a support surface;
a nonstick coating on at least a portion of the support surface; and
an object release element positioned over the support surface and including an adhesive coating on at least a portion of a lower surface thereof, the adhesive coating securing the object release element to the nonstick coating.

2. The programmable material consolidation system of claim 1, wherein the fabrication site is configured to receive or contain a quantity of unconsolidated material.

3. The programmable material consolidation system of claim 2, wherein the unconsolidated material comprises a photopolymer.

4. The programmable material consolidation system of claim 3, wherein the unconsolidated material comprises ultraviolet-curable material.

5. The programmable material consolidation system of claim 1, wherein the nonstick coating comprises a fluorine-containing polymer.

6. The programmable material consolidation system of claim 1, wherein the object release element includes a substrate with an upper surface to which at least one fabricated object will adhere during fabrication thereof and which is readily removable from the at least one fabricated object following fabrication thereof.

7. The programmable material consolidation system of claim 6, wherein the substrate comprises a material to which the at least one fabricated object will adhere during fabrication thereof and which is readily removable from the at least one fabricated object following fabrication thereof.

8. The programmable material consolidation system of claim 7, wherein the substrate comprises at least one of polyethylene, polyethyleneteraphthalate, and polyethylene ethyl ketone.

9. The programmable material consolidation system of claim 6, further comprising:
an object release coating on at least a portion of an upper surface of the substrate, the object release coating comprising a material to which the at least one fabricated object will adhere during fabrication thereof and which is readily removable from the at least one fabricated object following fabrication thereof.

10. The programmable material consolidation system of claim 9, wherein the object release coating comprises at least one of polyethylene, polyethyleneteraphthalate, and polyethylene ethyl ketone.

11. The programmable material consolidation system of claim 1, wherein the adhesive coating comprises a polymer which is tacky when in an uncured state and nontacky when in a substantially cured state.

12. The programmable material consolidation system of claim 11, wherein the polymer comprises a radiation-curable polymer.

13. The programmable material consolidation system of claim 12, further comprising:
a source of electromagnetic radiation of at least one wavelength that will cure the radiation-curable polymer.

14. The programmable material consolidation system of claim 12, wherein the radiation-curable polymer comprises an ultraviolet-curable polymer.

15. The programmable material consolidation system of claim 11, wherein, when in the substantially cured state, the adhesive coating will have reduced adhesion to the nonstick coating.

16. A programmable material consolidation system, comprising:
a fabrication site;
a platen within the fabrication site and including a support surface and at least one port through which a negative pressure may be applied to the support surface; and
an object release element positioned over and secured to the support surface with the negative pressure.

17. The programmable material consolidation system of claim 16, wherein at least a lower surface of the object release element comprises a material that seals against the support surface at least when the negative pressure is applied to the lower surface.

18. The programmable material consolidation system of claim 16, wherein the fabrication site is configured to receive or contain a quantity of unconsolidated material.

19. The programmable material consolidation system of claim 18, wherein the unconsolidated material comprises a photopolymer.

20. The programmable material consolidation system of claim 19, wherein the unconsolidated material comprises ultraviolet-curable material.

21. The programmable material consolidation system of claim 16, wherein the object release element includes a substrate with an upper surface to which at least one fabricated object will adhere during fabrication thereof and which is readily removable from the at least one fabricated object following fabrication thereof.

22. The programmable material consolidation system of claim 21, wherein the substrate comprises a material to which the at least one fabricated object will adhere during fabrication thereof and which is readily removable from the at least one fabricated object following fabrication thereof.

23. The programmable material consolidation system of claim 22, wherein the substrate comprises at least one of polyethylene, polyethyleneteraphthalate, and polyethylene ethyl ketone.

24. The programmable material consolidation system of claim 6, further comprising:
an object release coating on at least a portion of an upper surface of the substrate, the object release coating comprising a material to which the at least one fabricated object will adhere during fabrication thereof and which is readily removable from the at least one fabricated object following fabrication thereof.

25. The programmable material consolidation system of claim 24, wherein the object release coating comprises at least one of polyethylene, polyethyleneteraphthalate, and polyethylene ethyl ketone.
